(19) United States
(12) Patent Application Publication
(10) Pub. No.: US 2005/0221228 A1
(43) Pub. Date: Oct. 6, 2005

(54) Near field optical storage mask layer, disk, and fabrication method

(75) Inventors: Xiaolei Shi, Niskayuna, NY (US); Lambertus Hesselink, Atherton, CA (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 10/814,697

(22) Filed: Mar. 30, 2004

(51) Int. Cl. G11B 7/24

(52) U.S. Cl. 430/270.13; 430/270.11; 430/19; 430/945; 430/270.12; 428/64.8; 369/288; 369/283

(57) ABSTRACT

A mask layer for a high-density near-field optical storage system includes nonlinear optical material and nanoparticles embedded in the nonlinear optical material. The mask layer in combination with a data layer is useful for forming an optical disk. One technique for storing data in the optical disk includes using a gate beam to modify an index of refraction in a modified portion of the nonlinear optical material using a signal beam to provide nanoparticle resonance excitation of selected nanoparticles within the modified portion of the nonlinear optical material.

### BACKGROUND

The invention relates generally to high-density optical storage systems that realize near-field storage in a removable disk (Super-RENS).

Near-field data storage is a candidate for future ultra-high capacity optical storage. One advantage of near-field data storage is that the data bit size is no longer limited by the optical diffraction limit. The optical diffraction limit is a fundamental limit in conventional optical storage systems such as CD or DVD systems.

In near-field storage systems, the light “head,” or optical stylus, which produces a tiny light spot that ultimately defines the data bit size, is in very close proximity (about half the spot size) to the data storage layer (disk medium). At least three main near-field storage systems are presently under development: a solid-immersion-lens (SIL) system, a very-small-aperture-laser (VSAL) system, and a super-resolution near-field storage (Super-RENS) system. In both the SIL and the VSAL approaches, the light head and the data disk are two separate units, and this makes removability of the disk from the player a more difficult problem to solve. In contrast, in the Super-RENS approach the light head is embedded in the storage disk through a specially designed “mask” layer. In other words, near-field storage is realized solely by the media disk. Thus the disk is more easily made removable, backward compatibility is more likely, and mechanical alignment costs are removed, but media complexity is increased.

The main elements of a Super-RENS disk are: a mask layer and a “data” layer. The two layers are sometimes separated with a spacer layer of a fixed thickness. The mask layer is used to provide a light head under signal beam illumination. The light head is used for the data read/write. The size of the optical spot produced by the light head ultimately determines the size of the data bit of the storage system.

Typically, the spot size of the light head is designed to be much smaller than the diffraction limit in order to achieve a smaller bit size and thus a higher data capacity. Another design goal is that the field intensity of the light head spot be high for both data bit writing and data bit readout to achieve a good signal to noise ratio and a good system power efficiency. Still another useful feature is that the light head be switchable. In other words, it is desirable for light head to be turned “on” with signal beam illumination and then switched “off” (back to its state before the illumination) after the signal beam illumination. Switchability is useful for repeated readout of disk data. Lastly, to provide a fast read/write speed of the system, the switch time of the light head should be fast. Currently, there are two major approaches to realize the above design factors of a Super-RENS light head in the mask layer: an aperture-type approach and a particle-type approach.

In the aperture-type approach, the mask layer is a thin film of phase change material, typically antimony (Sb). Under light illumination, the original crystal phase Sb turns into amorphous phase Sb. The amorphous Sb is a dielectric-like material whereas the crystal Sb is a metallic-like material. Therefore, in effect, an “aperture” is formed under the light illumination. Adjusting the shape of the illumination pulse can modify the aperture size. After the illumination, the amorphous Sb naturally relaxes back to the crystal Sb phase. The phase transition of the Sb takes place typically on the order of picoseconds. A limitation of the aperture approach is the low field intensity from the aperture due to the fact that that optical transmission through a small aperture decays as the 4th power of the aperture size. Typically, the optical transmission efficiency through a 100 nanometer (nm) aperture ranges from about 10⁻³ to about 10⁻⁵, compared with a normalized input intensity of 1.

In the particle-type Super-RENS, the mask layer is a thin film of a metal oxide layer, typically silver oxide (AgOx). Under light illumination, AgOx is expected to decompose into Ag particles and O₂. The Ag particles are then used as the light head for read/write. After the illumination, the Ag and O₂ are expected to recombine back to the original AgOx state before the illumination. The chemical decomposition and recombination process can take place in the range of about 400° C. to about 500° C., therefore, the chemical switch speed is expected to be fast. In this approach, strong local fields are expected from the Ag particles due to a plasmon resonance. However, the present particle-type Super-RENS system has reliability issues in that the readout signal can decay under multiple readouts, perhaps due to gas bubbles that are formed from released O₂.

It would therefore be desirable to combine both advantages of the aperture and the particle approaches so that a spot with both high-resolution and high local field intensity can be achieved.

### BRIEF DESCRIPTION

Briefly, in accordance with one embodiment of the present invention, a mask layer for a high-density near-field optical storage system comprises a nonlinear optical material and nanoparticles embedded in the nonlinear optical material.

In accordance with another embodiment of the present invention, an optical disk comprises a data layer, and a mask layer overlying the data layer and comprising a nonlinear optical material and nanoparticles embedded in the nonlinear optical material.

In accordance with another embodiment of the present invention, a method of storing data comprises providing an optical disk comprising a data layer and a mask layer overlying the data layer and comprising a nonlinear optical material and nanoparticles embedded in the nonlinear optical material; using a gate beam to modify an index of refraction in a modified portion of the nonlinear optical material; and using a signal beam to provide nanoparticle resonance excitation of selected nanoparticles within the modified portion of the nonlinear optical material.

### DRAWINGS

These and other features, aspects, and advantages of the present invention will become better understood when the following detailed description is read with reference to the accompanying drawings in which like characters represent like parts throughout the drawings, wherein:

FIG. 1 is a sectional side view of a Super RENS fabrication assembly in accordance with one embodiment of the present invention.

FIG. 2 is a top view of the mask layer of the assembly of FIG. 1.

### DETAILED DESCRIPTION

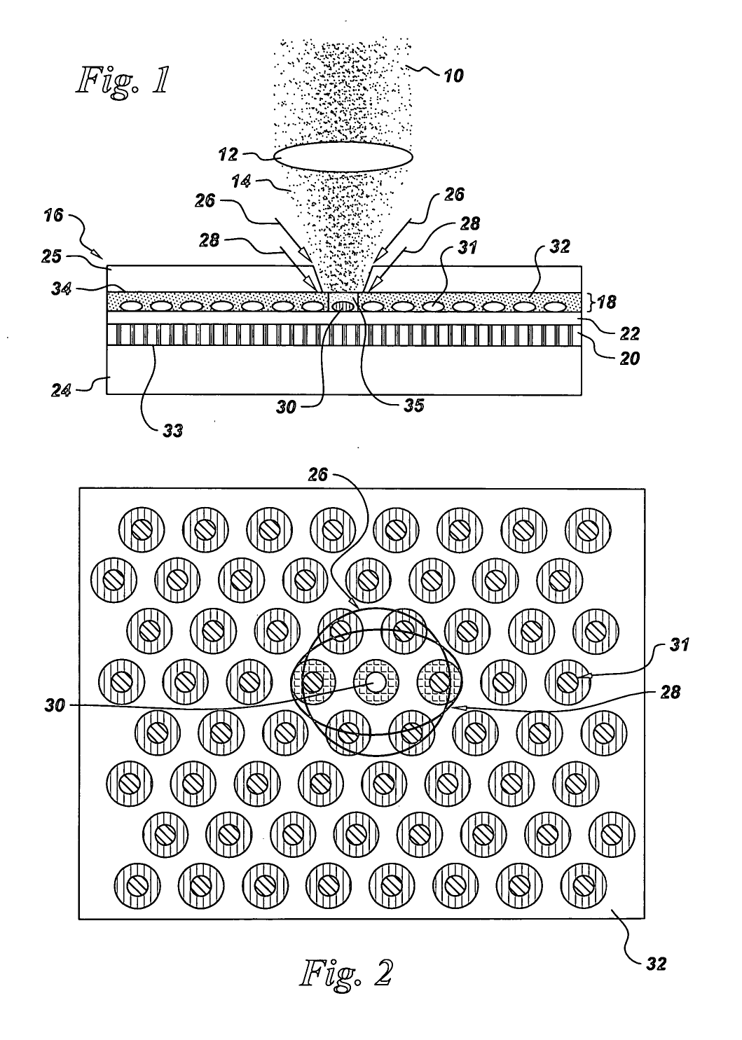

FIG. 1 is a sectional side view of a Super RENS fabrication assembly in accordance with one embodiment of the present invention, and FIG. 2 is a top view of the mask layer of the assembly of FIG. 2.

In one embodiment, a mask layer 18 for a high-density near-field optical storage system comprises nonlinear optical material 32 and nanoparticles 30 and 31 embedded in the nonlinear optical material. This mask layer embodiment combines both the aperture and the particle advantages so that a spot with both high-resolution and high local field intensity may be achieved. For example, by pre-embedding the nanoparticles instead of producing nanoparticles through chemical reactions, the,gas bubble issue of the particle-type approach is removed.

In a more specific aspect of the mask layer embodiment, at least part of the nonlinear material comprises a material selected from the group consisting of phase change materials, photo-refractive materials, photo-chromatic materials, and combinations thereof. One example of a useful phase change nonlinear material comprises antimony. Organic materials with appropriately tailored refractive index changes can also be useful as the nonlinear material. Typically the mask layer will be on the order of about 50 nanometers, for example.

In another more specific aspect of the mask layer embodiment, the nanoparticles comprise metallic nanoparticles. Two example materials for the metallic nanoparticles are silver and gold. In a more specific aspect regarding the shape of the nanoparticles, the nanoparticles comprise rods. Other shapes are discussed below. In one still more specific aspect, the rods comprise widths of about 20 nanometers and lengths of about 50 nanometers. In another still more specific aspect, the nanoparticles comprise vertically aligned nanoparticles.

Generally the nanoparticles are not coupled and are uniformly dispersed in the nonlinear optical material. The nanoparticles may be dispersed using self-assembly or nanolithography methods, for example. Dispersion techniques are described in literature with several examples being Chad A. Mirkin, Programming the Assembly of Two- and Three-Dimensional Architectures with DNA and Nanoscale Inorganic Building Blocks, Inor. Chem 2000, 39, 2258-2272, and Peter R. Krause et al., Nano-compact disks with 400 Gbit/in² storage density fabricated using nanoimprint lithography and read with proximal probe, Appl. Phys. Lett. 71 (21), November 1997, 3174-3176, for example.

In one aspect of the mask layer embodiment, the nanoparticles comprise coated nanoparticles. Coatings on nanoparticles may be useful to avoid nanoparticle aggregation issues and to provide nanoparticle surface protection. In a more specific aspect, a coating of the coated nanoparticles comprises oligonucleotides functionalized on the 5′ or 3′ end with alkylthiol. Typically coatings are formed on the nanoparticles during fabrication via chemical processes such as described, for example, in Chad A. Mirkin et al., A DNA-based method for rationally assembling nanoparticles into macroscopic materials, Nature, Vol. 382, Aug. 15, 1996, 607-609.

In another embodiment, mask layer 18 is used in an optical disk. The optical disk comprises a data layer 20 with the mask layer 18 overlying the data layer. Mask layer 18 may comprise nonlinear materials and nanoparticles such as those described above in the mask layer embodiment. In this embodiment “overlaying” is used for purposes of description and not to imply that either layer is on “top” of the other.

Additionally “overlaying” is used to mean either in direct physical contact or separated by another layer. For example, in one more specific aspect of the optical disk embodiment, the optical disk further comprises a spacer layer 22 between the data and mask layers. Spacer layers provide an interface for the data layer at the expense of requiring additional laser power for writing and reading the optical disk. Examples of spacer materials include ZnS—SiO₂ and SiN. Typically the thickness of a spacer layer ranges from about five nanometers to about twenty nanometers.

Optical disk 16 typically also comprises a substrate (shown as substrate portions 24 and 25 in FIG. 1) situated on at least one of outer surfaces 33 and 34. The substrate is beneficial for protecting the surfaces of the optical disk and may comprise polycarbonate or other conventional optical disk material, for example.

Data layer 20 may comprise any suitable recordable material and typically has a thickness ranging from about fifteen nanometers to about twenty-five nanometers. One example material is Ge₂Sb₂Te₅. Another example material is a dye doped organic material such as used for conventional CD-R disks.

In another embodiment, a method of storing data comprises providing an optical disk 16 of the type described above in the optical disk embodiment, using a “gate” beam 26 to modify an index of refraction in a modified portion 35 of the nonlinear optical material 32; and using a “signal” beam 28 to provide nanoparticle resonance excitation of selected nanoparticles 30 within the modified portion 35 of the nonlinear optical material 32.

The gate beam is used to provide high spatial resolution (selectivity) by causing an index change in nonlinear optical material 32. In the modified portion 35 of the nonlinear optical material 32, the resonance wavelengths of the individual nanoparticles spread out spectrally. Thus, a dynamic effective aperture is formed in the nonlinear optical material. Since the plasmon resonance frequency of the nanoparticles depends on the refractive index of the local environment of the nanoparticles (as described in Jack J. Mock et al., Local Refractive Index Dependence of Plasmon Resonance Spectra from Individual Nanoparticles, Nano Letters, Vol. 3, No. 4, 2003, 485-491), nanoparticles inside the aperture resonate at a different wavelength from those outside the aperture. The refractive index change may be performed in any effective manner with thermal and photo-refractive changes being two examples. When the nonlinear optical material refractive index changes, the resonance wavelength of the nanoparticles inside also changes.

The narrow line-width signal beam is additionally used to provide selectivity and strong local fields by causing nanoparticle resonance excitation. The signal beam illumination results in only few nanoparticles whose resonant wavelengths match the signal beam wavelength and are resonantly excited. The resonant nanoparticles provide a strong local field, which can be used for data recording or readout. By matching the conditions right, the nanoparticles inside the aperture can be selected to resonate at the wavelength of the optical signal beam. As a result, the resonant nanoparticles inside the aperture provide both a high local field and a high resolution.

When the gate beam is then turned off, the refractive index of the nonlinear material relaxes back to its original value as before the gate beam illumination. The nanoparticle resonance is therefore turned off. The nanoparticle resonance can be turned on/off within a few femto seconds, so the switch speed is determined by the nonlinear material.

Publications are available which describe tuning of resonance wavelengths. Resonance wavelength of a metallic nanoparticle can be tuned widely by several factors including nanoparticle material and composition, nanoparticle size, nanoparticle geometry, and the nanoparticle local environment. Additional design parameters for use in embodiments of the present invention include selection of the nonlinear optical material as well as the wavelength and polarization mode of the incident light.

As one example, in a study of nanoparticle materials in C. Sonnichsen et al., Plasmon resonances in large noble-metal clusters, New Journal of Physics, Vol. 4, 93.1-93.8, 2002, it was found that silver and gold have widely tunable wavelengths from the ultraviolet spectrum to the infrared spectrum. The same article also offers descriptions of the effect of nanoparticle size on resonance with resonance wavelengths (for gold spheres) being “red-shifted” and line-width being increased for increasing nanoparticle size. It is expected that nanoparticles of less than or equal to about 50 nm would be particularly useful.

As another example, in a study of nanoparticle geometry in C. Sonnichsen et al., Drastic Reduction of Plasmon Damping in Gold Nanorods, Physical Review Letters, Vol 88, No.7, 077402-1, 2002, when comparing gold spheres and rods, the resonance wavelength was red-shifted in rods and the resonance line-width was reduced in rods as compared with spheres. In another geometry example, in Yugang Sun et al., Increased Sensitivity of Surface Plasmon Resonance of Gold Nanoshells Compared to That of Gold Solid Colloids in Response to Environmental Changes, Analytical Chemistry, Vol. 74, No. 20, Oct. 15, 2002, 5297-5305, gold nanoshells showed ˜5-7 times higher sensitivity in response to the local environment as compared with solid colloids of about the same size or even smaller. In another geometry example, in aforementioned Jack J. Mock et al., Local Refractive Index Dependence of Plasmon Resonance Spectra from Individual Nanoparticles, Nano Letters, Vol. 3, No. 4, Feb. 25, 2003, 485-491, silver spheres, pentagons, and triangular (best resonance wavelength tunability with the change of local refractive index) nanoparticles were compared. It is thus expected that triangular shapes or rod shapes or shell structures are particularly useful with a rod ration example being 3:1 (length : diameter).

Resonance line-width of a nanoparticle depends on both radiative damping and nonradiative damping. The radiative damping is proportional to the square of the volume of the nanoparticle, and can be reduced by reducing the nanoparticle size. The nonradiative damping is limited by materials, and varies with the resonance wavelength. Combining the data from several geometry studies, J. Bosbach et al., Ultrafast Dephasing of Surface Plasmon Excitation in Silver Nanoparticles: Influence of Particle Size, Shape, and Chemical Surrounding, Physical Review Letters, Vol. 89, No. 25, 257404, 2002, and aforementioned C. Sonnichsen et al., Drastic Reduction of Plasmon Damping in Gold Nanorods, Physical Review Letters, Vol 88, No.7, 077402-1, 2002, it appears that, in general, resonance line-widths ranging from about 30 nanometers (nm) to about 35 nm can be achieved in a single nanoparticle.

Typically, the gate and signal beams will operate in a wavelength range from about 400 nanometers to about 800 nanometers and a power range from about five milliwatts to about 10 milliwatts. Specific wavelengths and power settings will depend on the nanoparticle and the mask material. In one embodiment the gate beam has a wavelength ranging from about 500 nanometers to about 800 nanometers and the signal beam has a wavelength ranging from about 600 nanometers to about 800 nanometers. In another embodiment which may be used separately from or in combination with the wavelength embodiment, the gate beam has a power ranging from about 5 milliwatts to about 10 milliwatts and the signal beam has a power ranging from about 10 milliwatts to about 40 milliwatts.)

While only certain features of the invention have been illustrated and described herein, many modifications and changes will occur to those skilled in the art. It is, therefore, to be understood that the appended claims are intended to cover all such modifications and changes as fall within the true spirit of the invention.

1. A mask layer for a high-density near-field optical storage system, the mask layer comprising:
a nonlinear optical material; and
nanoparticles embedded in the nonlinear optical material of the mask layer.

2. The mask layer of claim 1 wherein at least part of the nonlinear material comprises a material selected from the group consisting of phase change materials, photo-refractive materials, photo-chromatic materials, and combinations thereof.

3. The mask layer of claim 2 wherein the nonlinear material comprises antimony.

4. The mask layer of claim 2 wherein the nonlinear material comprises an organic material.

5. The mask layer of claim 1 wherein the nanoparticles comprise metallic nanoparticles.

6. The mask layer of claim 5 wherein the metallic nanoparticles comprise silver.

7. The mask layer of claim 5 wherein the metallic nanoparticles comprise gold.

8. The mask layer of claim 5 wherein the nanoparticles comprise rods or shell structures.

9. The mask layer of claim 8 wherein the nanoparticles comprise rods having widths of about 20 nanometers and lengths of about 50 nanometers.

10. The mask layer of claim 8 wherein the nanoparticles comprise vertically aligned nanoparticles.

11. The mask layer of claim 5 wherein nanoparticles comprise coated nanoparticles.

12. The mask layer of claim 11 wherein a coating of the coated nanoparticles comprises oligonucleotides functionalized on the 5′ or 3′ end with alkylthiol.

13. An optical disk comprising:
a data layer;
a mask layer overlying the data layer and comprising a nonlinear optical material and nanoparticles embedded in the nonlinear optical material.

14. The optical disk of claim 13 further comprising a spacer layer between the data and mask layers.

15. The optical disk of claim 14 wherein the spacer layer comprises ZnS—SiO₂.

16. The optical disk of claim 14 wherein the spacer layer comprises SiN.

17. The optical disk of claim 14 further comprising a substrate situated on at least one outer surface of the optical disk.

18. The optical disk of claim 13 wherein the data layer comprises Ge₂Sb₂Te₅.

19. The optical disk of claim 13 wherein the data layer comprises a dye doped organic material.

20. The optical disk of claim 13 wherein at least part of the nonlinear material comprises a material selected from the group consisting of phase change materials, photo-refractive materials, photo-chromatic materials, and combinations thereof.

21. The optical disk of claim 20 wherein the nonlinear material comprises antimony.

22. The optical disk of claim 20 wherein the nonlinear material comprises an organic material.

23. The optical disk of claim 13 wherein the nanoparticles comprise metallic nanoparticles.

24. The optical disk of claim 23 wherein the metallic nanoparticles comprise silver.

25. The optical disk of claim 23 wherein the metallic nanoparticles comprise gold.

26. The optical disk of claim 23 wherein the nanoparticles comprise rods or shell structures.

27. The optical disk of claim 26 wherein the nanoparticles comprise rods having widths of about 20 nanometers and lengths of about 50 nanometers.

28. The optical disk of claim 26 wherein the nanoparticles comprise vertically aligned nanoparticles.

29. The optical disk of claim 23 wherein nanoparticles comprise coated nanoparticles.

30. The optical disk of claim 29 wherein a coating of the coated nanoparticles comprises oligonucleotides functionalized on the 5′ or 3′ end with alkylthiol.

31. A method of storing data comprising:
(a) providing an optical disk comprising a data layer and a mask layer overlaying the data layer and comprising a nonlinear optical material and nanoparticles embedded in the nonlinear optical material;
(b) using a gate beam to modify an index of refraction in a portion of the nonlinear optical material, the portion comprising a modified portion; and
(c) using a signal beam to provide nanoparticle resonance excitation of selected nanoparticles within the modified portion of the nonlinear optical material.

32. The method of claim 31 wherein (a) comprises providing the optical disk with a spacer layer between the data and mask layers.

33. The method of claim 31 wherein the gate beam has a wavelength ranging from about 500 to about 800 nanometers and the signal beam has a wavelength ranging from about 600 to about 800 nanometers.

34. The method of claim 33 wherein the gate beam has a power ranging from about 5 to 10 milliwatts and the signal beam has a power ranging from about 10 to about 40 milliwatts.
